(19) United States
(12) Patent Application Publication
(10) Pub. No.: US 2005/0276669 A1
(43) Pub. Date: Dec. 15, 2005

(54) Punch assembly with spinning head

(76) Inventor: Earl T. Pottorff, Savannah, NY (US)

Correspondence Address: BERNHARD P. MOLLDREM, JR., 224 HARRISON STREET, SUITE 200, SYRACUSE, NY, 13202, US

(21) Appl. No.: 10/867,245

(22) Filed: Jun. 14, 2004

(51) Int. Cl. B23B 39/00

(52) U.S. Cl. 408/97

(57) ABSTRACT

A spinning-head punch assembly has a crown-shaped cutting head that rotates at a high rate of speed, creating high quality holes in webs of plastic film or other materials. A rotary drive such as an electric motor is mounted on a reciprocating carriage above an apertured backing plate, and a pneumatic cylinder is actuated to thrust the cutting head toward the web. A spring biased clamp holds the web firmly around the die hole. In the first part of the punch cycle, the clamp closes down onto the web, and then the spinning cutting head contacts the web. The teeth on the web pierce the material so the punch cuts a clean hole, and does not pull or tear the material. Then on the second part of the punch cycle, the pneumatic cylinder lifts the cutting head away from the web material, and as the carriage reaches the top of its stroke the clamp releases the web so that it can advance to the next hole location.

### BACKGROUND OF THE INVENTION

The present invention relates to punches and apparatus for perforating film material such as polyethylene film or other films made of plastic resin. The invention is more particularly directed to apparatus for making holes and perforations in a web or sheet of a plastic film. The invention is specifically directed to a punch assembly that can hold the web down while the holes are being formed, and which can be operated at a high speed without tearing or damaging the web material.

Blades, punches, and cutters for forming holes and slits in plastic film material are described in prior U.S. Pat. Nos. 4,748,920 and 4,723,466 of Earl T. Pottorff. There, a self-sharpening hole punch formed of a low-friction, semi-rigid material, such as a polymer or a similar plastic resin. The hole punch has a thread at its upper end for screw-mounting onto reciprocating apparatus, which may be actuated by a pneumatic cylinder. These hole punches may have a generally cylindrical, crown-shaped cutting head with a series of teeth formed around the lower circular edge.

A so-called quick-slip punch adapter for a plastic bag making machine is described in U.S. Pat. Nos. 5,035,165 and 5,114,394. Typically, there are several of these on each bag machine. U.S. Pat. No. 6,148,710 concerns a slitter and hole punch and quick change adapter combination which fits a bag machine or similar equipment for punching holes and slits in a web of plastic film material. In that arrangement, a hole punch and a slitter blade are unitarily formed on a base member. Left and right resilient arms extend from distal to proximal, and have free ends that project proximally of the base member. The quick adapter can have a T-channel formed on a lower side to accommodate the replaceable hole punch and the slitter blade. The punches can be color coded for barrel diameter, gap size, etc. A slitter punch may be used in combination with a hold-down plate arrangement that clamps the film in place momentarily while the punch mechanism is fired, and then releases the film immediately thereafter. In some designs, a spring is used to bias between the cutting head and the frame on which the hold-down plate is mounted.

There do exist paper drills, i.e., machines for punching holes in stacks of paper sheets, which have hollow rotary drill spindles. These are rotated at some speed, and the drills cut holes in the paper as the rotary drill descends through the stack of paper. Some examples are found, for example, in U.S. Pat. Nos. 4,632,611 and 5,108,242. These may be provided with hold down clamping arrangements to hold the paper in place when the holes are being drilled. However, the hollow spindle is invariably provided without cutting teeth at its tip, and would not serve well for cutting through plastic film cleanly, without pulling or tearing it.

It has been desired to be able to use a plastic-head punch on films of various compositions and a wide variety of thicknesses, as well as on materials that may include some fiber content (e.g., paper or paper-filled materials), but existing punches have not provided excellent service for the entire range of common web materials.

### OBJECTS AND SUMMARY OF THE INVENTION

Accordingly, it is an object of this invention to provide a hole cutter or hole punch which can be used for punching holes and perforations in webs of a wide variety of types and thicknesses of material, and which avoids the drawbacks of the prior art.

It is an important object to provide a punch that cuts very high quality holes in plastic film web, where the web may be of a wide variety of materials and thicknesses, including ultra-thin film materials such as vinyl film food wrap, and wherein the punch can also form high quality holes in mixed plastics-fiber material, as well as cardboard and fiber board.

It is another object of the invention to provide a hole punch assembly which can be easily changed over to create holes of various diameters.

It is a further object to provide a punch and hold-down clamp arrangement that is of simple design for long life and low maintenance costs.

According to one aspect of the present invention, the cutting head of the hole punch rotates at high speed. The cutting head is rotating at the time that the punch unit commences a punch cycle. A pulse signal is sent to a controller to open a pneumatic valve and begin the punch cycle. In the initial phase of the punch cycle, a pneumatic cylinder is actuated and the cylinder thrusts the punch towards the web, i.e., film. The clamp descends to hold the web firmly against the backing plate around the die hole, and then the spinning cutting head passes through the web and the die hole. The head is spinning at a high rate of speed, e.g., 5,000 RPM or more, and the teeth on the cutting head cut a perfect or nearly perfect hole. On the second half of the cycle, the air valve shifts so that the pneumatic cylinder reverses itself and lifts the punch out of the web. Just before the punch reaches the top of its throw, the clamp is picked up away from the web, so the web can advance to the next location where a hole is to be formed. The punch assembly is capable of speeds of 300 cycles per minute.

A preferred embodiment of this invention has an apertured backing plate on which the web of film is supported, a rotary cutting head for punching a hole in the web, and a pneumatic reciprocating assembly that holds the head in registered alignment with the web and with a corresponding aperture or die in the backing plate, such that the cutting head moves vertically, that is, in the direction that is substantially normal to the backing plate. The cutting head cycles up and down in the direction normal to the backing plate and the web. A hold-down clamp mechanism has a clamping plate is situated above the backing plate and has an aperture aligned with the corresponding aperture in the backing plate. The cutting head passes through this aperture when the hold-down clamp is biased against the web. The reciprocating assembly is operatively coupled to the clamping plate to press the clamping plate against the backing plate when the cutting head descends and to lift the clamping plate off the backing plate when the cutting head rises. A rotary drive, e.g., an electric motor with its shaft axis aligned with the punch axis, mounts the cutting head and spins the rotary head at the desired speed.

Favorably, the cutting head takes the form of a generally cylindrical crown member, with a hub that is mounted on the drive shaft, and with a circular row of tapered, serrated cutting teeth that are beveled to form cutting edges at the periphery of the lower side of the head. The cutting head may be formed of a flexible semi-rigid resin material, e.g., Delrin or another suitable plastic resin.

The cutting heads are interchangeable, and can be of any of a wide range of diameters. The punch arrangement can have support or base member, with a frame portion onto which a removable apertured insert plate is mounted, so that the insert plate can be interchanged with another similar plate whose aperture matches the diameter of the interchangeable cutting head.

The reciprocating assembly can include a pair of vertical posts mounted on the base or support member, and normal to the backing plate, a pair of slide tubes or barrels mounted respectively on these posts for sliding along them for at least a limited vertical distance, and a carriage plate supported upon said slide tubes. The rotary drive, e.g., the electric motor, is then favorably mounted on the carriage plate, so that the punch head reciprocates when the carriage plate is lowered and lifted by action of the pneumatic cylinder. In this embodiment, the hold-down clamp can have a mount, which may be cylindrical in shape, situated on the underside of the carriage plate surrounding the cutting head, with the clamping plate being favorably in the shape of a clamp ring. The clamp ring is held to the mount by posts and springs, or similar resilient means, such that the clamping plate reciprocates in response to movement of the carriage plate and the rotary cutting head.

The punches may incorporate a slitter adjacent the hole punch so as to form a hole and a slit simultaneously. Also, while terms of orientation, such as vertical, downward, left and right are used in respect to the embodiment described below, it should be appreciated that such terms are used for simplifying the description, and that the principles of this invention would be the same regardless of the positional orientation of the apparatus.

The above and many other objects, features, and advantages of this invention will become apparent from the ensuing description of an exemplary embodiment, which should be read in conjunction with the accompanying Drawing.

### BRIEF DESCRIPTION OF THE DRAWING

FIG. 1 is a perspective view of a hole punch arrangement according to the prior art.

FIG. 2 is a perspective view of a hole punch arrangement according to one preferred embodiment of this invention.

FIG. 3 is schematic, partly cut away elevational view of a portion of this embodiment.

FIG. 4 is an assembly view of this embodiment.

### DETAILED DESCRIPTION OF THE PREFERRED EMBODIMENT

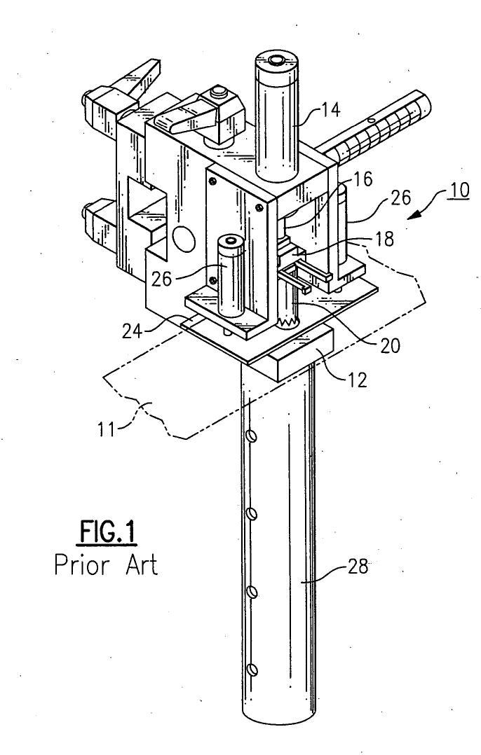

With reference to the Drawing, FIG. 1 illustrates a hole punch assembly 10 according to the state of the art, for punching holes into a web of plastic film 11. An apertured backing plate 12 supports the film 11, and has a round opening with which the hole punch blade or cutter head is aligned. A reciprocating actuator 14 has a shaft 16 that moves up and down with respect to the backing plate, and a vertical channel (not shown here) is situated distally of the shaft 16 for maintaining alignment of the assembly. Here, a punch and quick adapter assembly 18, e.g., as described in U.S. Pat. No. 6,148,700, can be fitted onto a threaded end of the shaft, and a punch head unit 20 fits into this adapter. The unit 20 has a circular hole punch that aligns with the opening in the apertured backing plate 12. As further shown in FIG. 1, a clamping plate 24 is situated between the hole punch unit 20 and the apertured backing plate 12. Here, the clamping plate has an opening or openings that correspond to the opening(s) in the backing plate 12, and align with them. L-shaped support shelves affixed on the left and right sides of the reciprocating mechanism, and each of these shelves mounts a respective air cylinder 26 which actuates to raise and lower the clamping plate 24 during a punch cycle. A waste tube 28 is shown beneath the backing plate to collect the punched-out waste that is removed from the web of film 11, so that the collected waste can be recycled or disposed of.

In some versions, the clamp plate 24 for the hole punch assembly may be spring actuated to rise and descend with the action of the cutting head or hole punch unit 20.

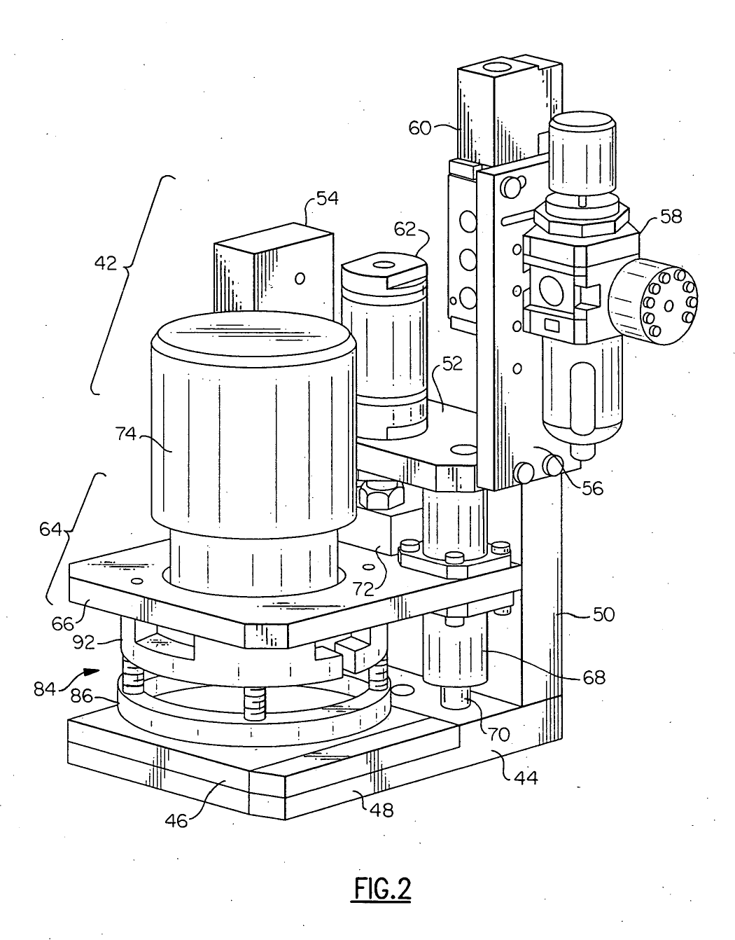

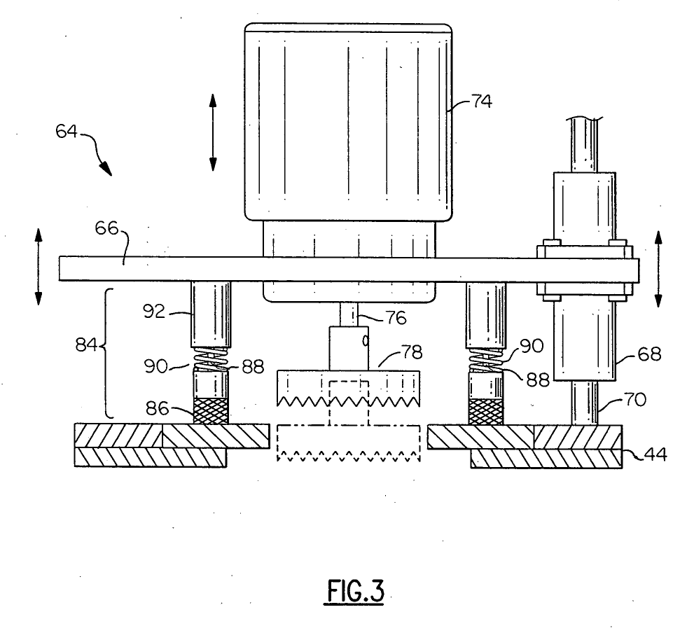

One preferred embodiment of the spinning-head hole punch of this invention illustrated in FIGS. 2, 3 and 4. A rotary head punch assembly 42 has a support plate or base plate 44 on which is mounted a removable, interchangeable apertured backing plate 46. The backing plate 46 here takes the form of a generally rectangular or square insert that fits atop a front frame portion 48 of the base plate 44.

A vertical back plate 50 rises from the base plate 44 and has a horizontal platform 52 mounted upon it for holding the actuation components. An electrical box 54 is fitted onto a box mount 55 on one side of the platform 52, and a pneumatic controls support plate 56 is mounted onto the other side of the platform. The plate 56 supports a pneumatic regulator 58 and an air valve 60. A double acting pneumatic cylinder 62 is supported centrally on the platform 52, with its rod extending downward. Electrical wiring and air hoses are omitted in these views, but would be present in the actual implementation of this embodiment.

A punch reciprocating assembly 64 has a horizontal punch carriage plate 66 positioned above the base plate 44, with a pair of vertically oriented tubular slide members 68, i.e., barrels, mounted at the distal side of the carriage plate 66 (one of these slide members 68 is obscured in these views). A portion of each of the tubular slide members extends above the plate 66 and another portion thereof descends below the plate.

A pair of vertical slide posts 70 rise from the base plate 44 and extend to the platform 52. The two tubular slide members 68 are respectively fitted over the posts 70, to guide the punch reciprocating assembly over at least a limited stroke distance.

There is an anchor block 72 at the distal side of the plate 66, onto which the piston rod of the actuator 62 is affixed.

A rotary drive, here an electric drive motor 74, is mounted centrally on the punch carriage plate 66, and is oriented with its shaft 76 vertical. A plastic rotary punch head 78 or cutting head is mounted onto the drive shaft 76 below the support plate 66.

In this embodiment, the cutting head 78 is formed of a semi-rigid flexible plastic resin, e.g., Delrin, which is an acetal homopolymer, although other suitable resins could be employed. The cutting head 78 is formed as a crown member, with a central stem extending upwards from a disk portion, and a cylindrical portion extending downward and ending in a row of tapered, serrated cutting teeth. The teeth are beveled to form cutting edges at the outer edge, i.e., periphery of the cutting head. The cutting action of the beveled teeth against the plastic film (not shown here) acts to wear the plastic material in a way that makes the cutting head self-sharpening. The teeth pierce the plastic film or other web material when the head descends against it, so that the spinning action will cut the material, rather than pull or tear it.

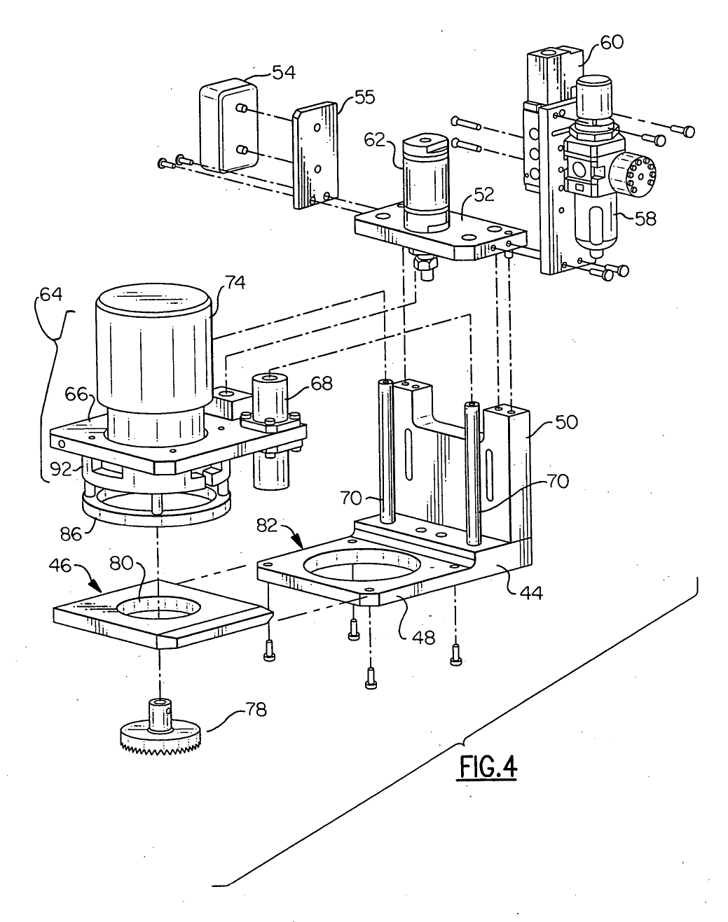

A circular die or aperture 80 is formed in the backing plate insert 46. The insert 46 is selected so that the aperture 80 has a diameter that matches the associated cutting head 78. As mentioned before, the insert 46 is interchangeable, as is the cutting head, and is shown here (FIG. 4) to rest in a recess 82 on top of the frame portion 48 of the base plate. As also shown, the frame portion is open, i.e., with a central opening at least large enough to accommodate the aperture 80 and cutting head 78. The insert is attached by bolts or similar fasteners (shown, but not numbered) at its corners.

A film clamp arrangement 84 is disposed beneath the support plate 66 and surrounding the punch head 78. A clamp ring 86 is supported on posts 88, and biased downwards by means of compression springs 90 positioned on the posts 88. The posts 88 fit slidably into a cylindrical support member 92 that is attached to the underside of the carriage plate 66. The clamp arrangement is operative such that when the punch reciprocating assembly 64 descends on the first part of a punch cycle, the clamp ring 86 contacts the web and biases it against the backing plate 46 around the die aperture 80. The springs 90 hold the clamp against the material as the head 78 descends and contacts the web. The spinning head cuts a circular hole in the web, and then the air valve 60 shifts to actuate the cylinder 62 upwards and commence the next phase of the cycle. The clamp 86 biases against the web material until the head 78 is lifted clear, and then the clamp 86 lifts free to release the web to move to the next punch location.

In this embodiment, the motor 74 is a high speed electric motor, with a fan incorporated, and rotationally drives the cutting head 78 directly. In other possible embodiments, a gear drive, or other transmission means could be employed, or the motor could be located off the support plate 68 so that it would not have to reciprocate up and down with the punch cycles. In other possible embodiments, a pneumatic air motor could be employed to spin the head 78.

Instead of a ring-shaped clamp as illustrated here, the clamp mechanism could employ a clamp plate of another overall shape, or the clamp could have more than one contact component.

A spinning head hole punch according to the principles of this invention can be employed for webs of materials other than plastic film, for example, cardboard or chipboard, as well as composite materials.

While this invention has been described in detail with reference to a selected preferred embodiments, it should be recognized that the invention is not limited to those embodiments.

Rather, many modifications and variations will present themselves to persons skilled in the art without departing from the scope and spirit of the invention, as defined in the appended claims.

1. A punch apparatus for punching round holes in a web of film material, said apparatus having an apertured backing plate on which said web is supported, a cutting head for punching a hole in said film material, reciprocating means for holding the head in registered alignment with said film material and with a corresponding aperture in said backing plate, and for moving the cutting head in a direction that is substantially normal to said backing plate, and for moving the cutting head in a direction that is substantially normal to the backing plate on which the web is supported, and a hold-down clamp that includes a clamping plate situated above the backing plate and having an aperture therein in alignment with the corresponding aperture in the backing plate, and through which the cutting head passes when the hold-down clamp is biased against the web on the backing plate, with the reciprocating means being operatively coupled to the clamping plate to urge the clamping plate against the backing plate when the cutting head descends and to lift the clamping plate off the backing plate when the cutting head rises;
comprising the improvement in which the reciprocating means further includes a rotary drive for rotating a drive shaft on which the cutting head is mounted such that the cutting head rotates about an axis thereof that is normal to said web and said backing plate.

2. A punch apparatus according to claim 1, in which said cutting head includes a generally cylindrical crown member carried on said drive shaft, the cutting head being formed of a flexible semi-rigid resin material with a plurality of tapered serrated cutting teeth that are beveled to form cutting edges at the periphery thereof.

3. A punch apparatus according to claim 1, in which said backing plate includes a support member having a frame and a removable insert plate mounted upon said frame, whereby the insert plate can be interchanged with another similar plate of a given aperture size to match the diameter of the cutting head for a range of sizes of such cutting heads.

4. A punch apparatus according to claim 1, wherein said rotary drive rotates said cutting head at a speed of 5,000 rpm.

5. A punch apparatus according to claim 1, wherein said reciprocating means is capable of operating speeds of 300 punch cycles per minute.

6. A punch apparatus according to claim 1, wherein said rotary drive includes an electric motor.

7. A punch apparatus according to claim 3, said reciprocating means includes a pair of posts mounted on said support member and normal to said backing plate, a pair of slide tubes mounted respectively on said posts for sliding therealong, and a carriage plate supported upon said slide tubes.

8. A punch apparatus according to claim 7, wherein said rotary drive means is mounted on said carriage plate to reciprocate therewith.

9. A punch apparatus according to claim 8, wherein said hold-down clamp includes a mount situated on said carriage plate surrounding said cutting head, and resilient means mounting said clamping plate beneath said mount, such that the clamping plate reciprocates with said carriage plate and said cutting head.
